(19) United States
(12) Patent Application Publication
(10) Pub. No.: US 2012/0018942 A1
(43) Pub. Date: Jan. 26, 2012

(54) Bracing apparatus

(76) Inventor: Blayde Penza, Sun Valley, CA (US)

(21) Appl. No.: 12/804,410

(22) Filed: Jul. 21, 2010

(51) Int. Cl. B23Q 3/00; F16M 13/00

(52) U.S. Cl. 269/287; 248/351

(57) ABSTRACT

An easy to use form bracing apparatus and the method of using same that can be quickly and easily used to accurately plumb and securely brace a generally vertically extending member such as a column form into which concrete is to be poured to form a concrete column. The bracing apparatus includes a collar assembly constructed and arranged to be secured about the member and first and second supporting surface engaging braces that are connected to the collar assembly. The collar assembly includes a strap that is selected from a plurality of straps of different lengths and a pair of spaced apart brace support assemblies that are connected to the selected strap. Each strap is provided with a plurality of strategically spaced apart locating elements that are used to locate the brace support assemblies at strategic locations along the length of the belt.

### CROSS-REFERENCE TO RELATED APPLICATIONS

Not Applicable

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The present invention relates generally to a concrete forming apparatus and the method of using the same. More particularly, the invention concerns a novel form bracing apparatus that is especially well suited for use in plumbing and bracing forms for pouring concrete columns.

2. Description of Related Art Including Information Disclosed Under 37 CFR 1.97 and 1.98

A common practice in the construction industry is to use elongate paper fiber tubes to form concrete columns. Once the tube is in place and properly anchored, it must be suitably plumbed and braced before concrete is poured into the interior of the tube and allowed to harden so as to form a column. After the concrete has hardened, the tube is stripped away from the concrete column and discarded.

Because of the drawbacks and the expense of paper forming tubes, the present inventor has developed a novel, lightweight, forming system that includes a reusable, flexible jacket that can be secured about a selected Styrofoam core. This forming system is illustrated and described in U.S. Publication No. 2009-0232606. As will be discussed in greater detail hereinafter, the form bracing apparatus of the present invention can be used with this forming system as well as with other prior art forming systems to plumb and brace the form into which the concrete is to be poured.

It is generally agreed by those skilled in the art that column forms must be plumbed and braced in two directions. In the past, this bracing is typically accomplished by nailing a 2×4 box-like structure near the top of the form and to a pair of stakes, generally also made from 2×4s that extend from the structure toward the supporting surface at an angle of approximately 45 degrees. However, some contractors prefer to use adjustable brace clamps of a character produced by various manufacturers.

These prior art procedures are quite cumbersome, very time-consuming and often produce inaccurate results.

Accordingly, the thrust of the present invention is to provide a reusable bracing system that is of simple construction, is easy to use with a minimum of instruction and one that accurately plumbs and securely braces the column form. When in position, the novel design of the bracing system ensures that the form remains plumb while the concrete is poured and during the concrete curing step.

### BRIEF SUMMARY OF THE INVENTION

By way of brief summary, in one embodiment of the invention, the form bracing apparatus comprises a collar assembly constructed and arranged to be secured about the form or about other generally vertically extending members and first and second supporting surface engaging braces that are connected to the collar assembly. The collar assembly includes a strap that is selected from a plurality of straps of different lengths and a pair of spaced apart brace support assemblies that are secured to the selected strap. Each strap is provided with a plurality of strategically spaced apart locator elements that are used to locate the brace support assemblies to the collar at the location of selected ones of said locator elements.

Each of the brace support assemblies comprises a base having a strap receiving opening and a pair of vertically spaced attachment members that are connected to and extend from the base. The support surface engaging braces are connected to the vertically spaced attachment members using suitable connectors.

With the forgoing in mind, it is an object of the present invention to provide an easy-to-use form bracing apparatus and the method of using same that can be quickly and easily used to accurately plumb and securely brace a generally vertically extending member such as the column form into which the concrete is to be poured.

Another object of the invention is to provide a form bracing apparatus that can be used to plumb and brace generally vertically extending members such as column forms of various types and of various diameters.

Another object of the invention is to provide a form bracing apparatus of the class described that is of simple construction and one that requires a minimum number of simple hand tools to accomplish the erection of the apparatus.

Another object of the invention is to provide a form bracing apparatus of the character described that is compact and easy to store and transport.

Another object of the invention is to provide a form bracing apparatus of the character described in the preceding paragraphs that is reusable and one that can be used by relatively untrained workmen with a minimum of instruction.

Another object of the invention is to provide a bracing apparatus of the class described that can be used to brace and stabilize a variety of different types of cylindrically shaped objects such as, for example, poles or steel pipes until permanent securement can be achieved.

These and other objects of the invention will be achieved by the novel apparatus illustrated in the drawings and described in the paragraphs which follow.

### BRIEF DESCRIPTION OF SEVERAL VIEWS OF THE DRAWINGS

FIG. 1 is a generally perspective view of one form of the bracing apparatus of the invention shown, interconnected with a column form to accurately plumb and securely support the column pouring form during the concrete pouring and curing steps.

FIG. 2 is a generally perspective view of a portion of the bracing system showing a portion of the strap assembly and illustrating the construction of one form of brace support assembly that is secured to the strap assembly.

FIG. 3 is a side elevational, foreshortened view further illustrating the construction of one of the brace support assemblies of the invention and the construction of one form of the elongate supporting surface engaging brace of the invention that is attached to the brace support assembly.

FIG. 4 is a view taken along lines 4-4 of FIG. 1.

FIG. 4A is a generally perspective fragmentary view illustrating the construction of the buckle of the strap assembly of the invention in an open configuration.

FIG. 4B is a generally perspective fragmentary view similar to

FIG. 4A illustrating in solid lines the strap buckle in a closed configuration.

FIG. 5 is a generally diagrammatic view illustrating one form of strap assembly of the invention and illustrating the positioning of the locating grommets along the length of the strap assembly.

FIG. 5A is a generally diagrammatic view illustrating an alternate form of strap assembly of the invention and illustrating the positioning of the locating grommets along the length of the strap assembly.

FIG. 5B is a generally diagrammatic view illustrating still another form of strap assembly of the invention and illustrating the positioning of the locating grommets along the length of the strap assembly.

FIG. 5C is a generally diagrammatic view illustrating yet another form of strap assembly of the invention and illustrating the positioning of the locating grommets along the length of the strap assembly.

FIG. 5D is a generally diagrammatic view illustrating still another form of strap assembly of the invention for use with larger diameter forms and illustrating the positioning of the locating grommets along the length of the strap assembly.

FIG. 5E is a generally diagrammatic view illustrating yet another form of strap assembly of the invention for use with still larger diameter forms and illustrating the positioning of the locating grommets along the length of the strap assembly.

FIG. 6 is a generally perspective view of a portion of an alternate form of bracing system of the invention showing a portion of the collar assembly and illustrating the construction of an alternate form of brace support assembly that is secured to the strap assembly.

FIG. 7 is a cross-sectional view taken along lines 7-7 of FIG. 6 further illustrating the construction of one of the brace support assemblies of the alternate form of the invention and the construction of the upper end of one form of the elongate supporting surface engaging brace of the alternate form of the invention that is attached to the brace support assembly.

FIG. 8 is a greatly enlarged view of the area designated in FIG. 7 by the numeral 8.

FIG. 9 is a top plan view of an alternate form of strap connector for interconnecting the ends of the strap component of this latest form of the invention.

FIG. 10 is a side elevational view of the alternate form of strap connector shown in FIG. 9.

### DETAILED DESCRIPTION OF THE INVENTION

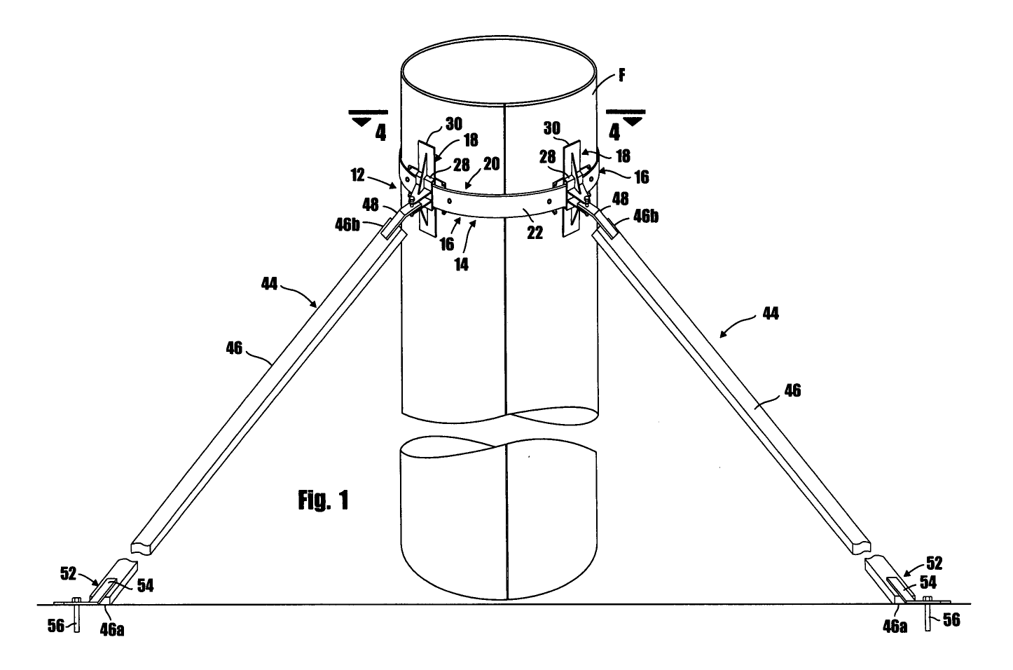

Referring to the drawings and particularly to FIG. 1, one form of the bracing apparatus of the invention is there shown interconnected with a generally vertically extending member, here shown as a column form, to brace and securely support the form during the concrete pouring and curing steps. The bracing apparatus, which is generally designated in FIG. 1 by the numeral 12, here comprises a collar assembly 14 that, as shown in FIG. 1, is constructed and arranged to be secured about an upright concrete column form “F” that can be used for pouring a concrete column. In the present form of the invention, the collar assembly 14 includes a strap assembly 16 and a plurality of circumferentially spaced brace support assemblies 18 that are connected to the strap assembly in a manner presently to be described.

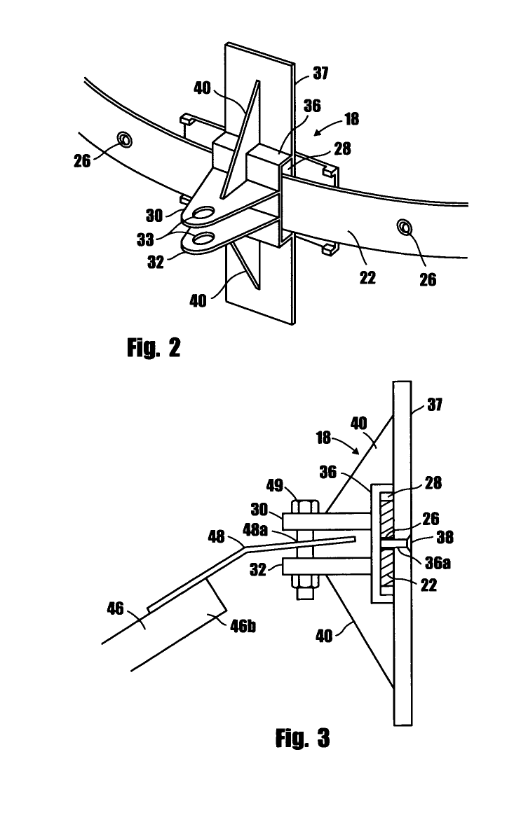

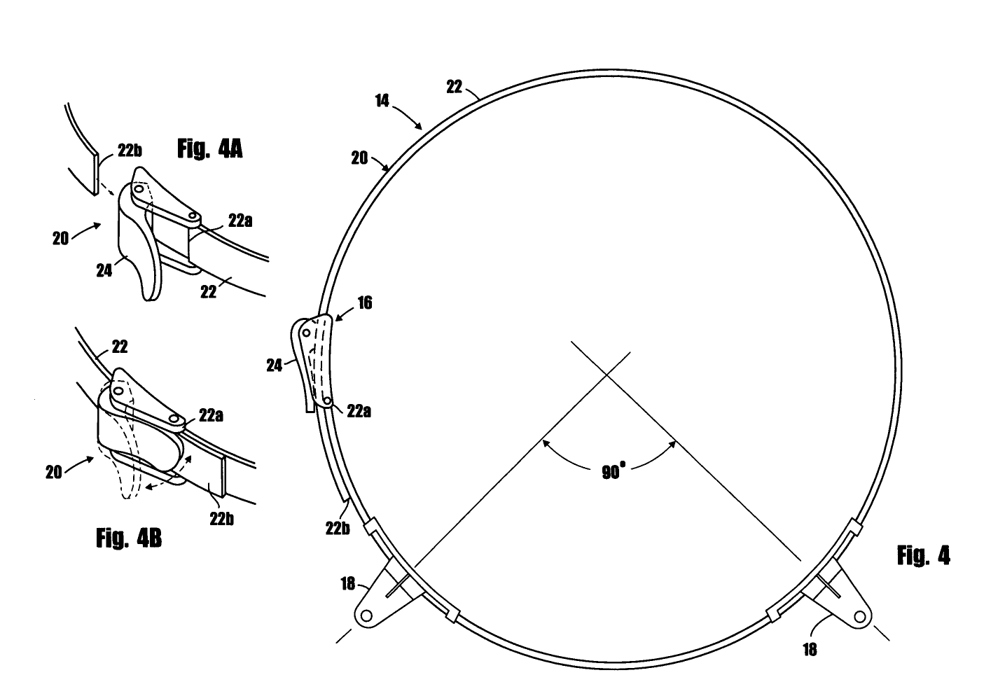

As illustrated in FIGS. 1, 2 and 4 of the drawings, the strap assembly 16 includes an elongated high tensile strap assembly 20 that can be adjusted to accommodate column forms of various diameters. Strap assembly 20 includes a strap 22 having first and second ends 22a and 22b that are releasably interconnected by a strap connector shown here as a standard buckle 24 of conventional design (FIGS. 4, 4A and 4B). Provided at strategically determined locations along strap 22 are locator elements, here shown as connector grommets 26, that, in a manner presently to be described, function to locate the brace support assemblies 18 at specific locations along the strap (FIG. 2).

As best seen in FIGS. 2 and 3 of the drawings, each of the brace support assemblies 18 includes a strap receiving opening 28 that telescopically receives the strap 22. Each of the brace support assemblies 18 also includes a pair of vertically spaced attachment members 30 and 32. For a purpose presently to be described, each of the attachment members is provided with an aperture 33. Attachment members 30 and 32 are connected to and extend from a generally U-shaped member 36. U-shaped member 36 is, in turn, connected to a generally vertically extending support 37 and cooperates therewith to define the strap receiving opening 28. Support 36 is provided with a threaded bore 36a that receives a threaded locating pin 38, the function of which will presently be described. Interconnecting the pair of vertically spaced attachment members 30 and 32 with the generally vertically extending support 36 are a pair of side supports 40.

Also forming an important part of the bracing apparatus of the present embodiment of the invention are elongate first and second brace assemblies 42 and 44 (FIG. 1). Each of the first and second brace assemblies includes an elongated brace 46 having a first surface engagement end 46a and a second end 46b that includes a connector member 48 that is receivable between and interconnected with the pair of vertically spaced attachment members 30 and 32 by means of a conventional bolt 49 that extends through apertures 33 and through an aperture 48a provided in connector member 48 (see FIG. 3). Connected to the second end 46b of each of the connector members is a connector assembly 52 that includes an apertured surface engaging member 54 and a securement stake 56. Stake 56 is receivable within the aperture of the apertured member 54 and, in the manner shown in FIG. 1, functions to secure the brace 46 in position.

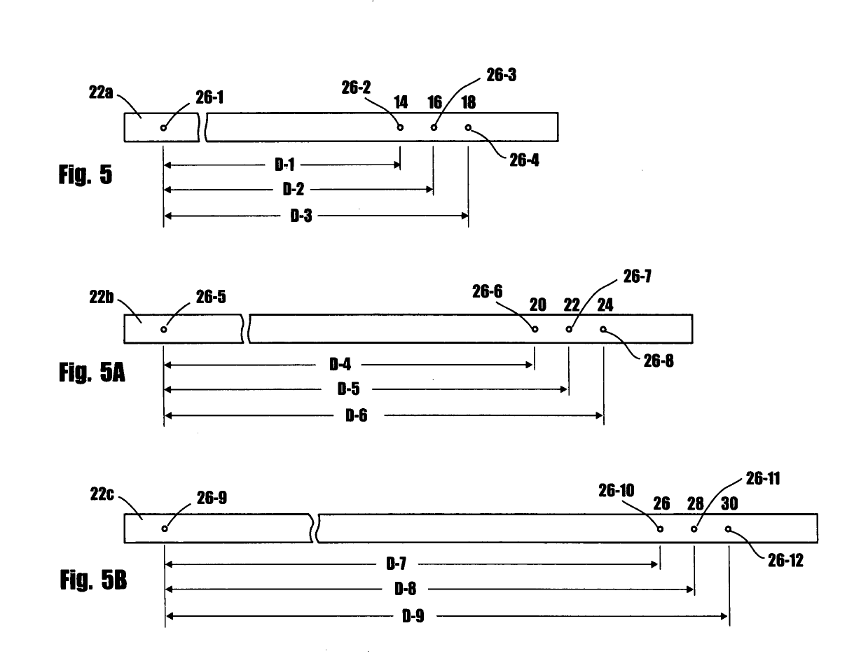

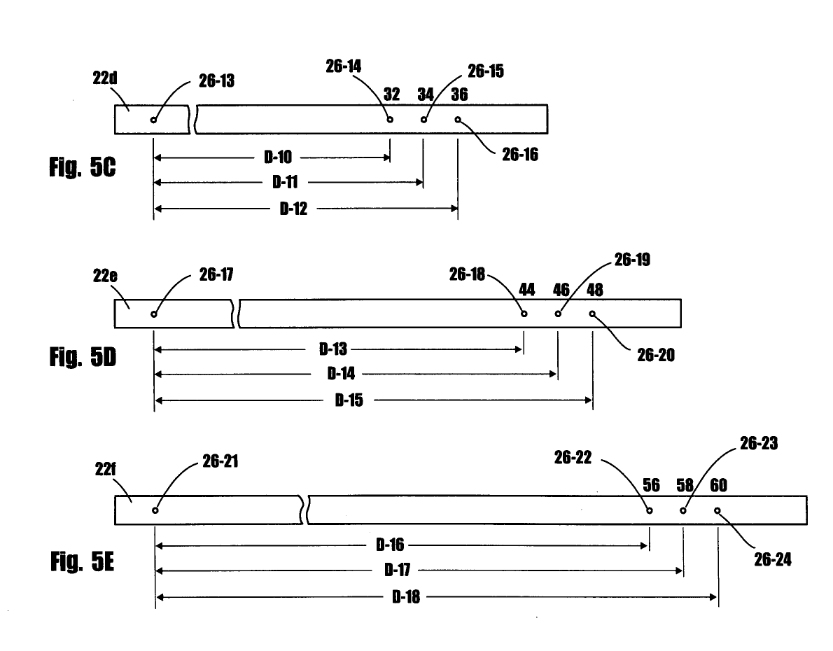

As illustrated in FIGS. 5, 5A, 5B, 5C, 5D and 5E, the bracing apparatus of the present invention includes a plurality of straps 22 of different lengths and different configurations. As indicated in the drawings, each of the straps illustrated in illustrated in FIGS. 5, 5A, 5B, 5C, 5D and 5E and identified as 22a, 22b, 22c, 22d, 22e and 22f, includes first, second, third and fourth strategically spaced apart locating elements, or generally circular grommets. For example, strap 22a is provided with a first grommet 26-1, a second grommet 26-2, a third grommet 26-3 and a fourth grommet 26-4.

Strap 22a is designed for use with forms having diameters of 14 inches, 16 inches and 18 inches. Accordingly, second grommet 26-2 is spaced from first grommet 26-1 by a distance “D-1” of approximately 33.75 inches, third grommet 26-3 is spaced from first grommet 26-1 by a distance “D-2” of approximately 37.75 inches and fourth grommet 26-4 is spaced from first grommet 26-1 by a distance “D-3” of approximately 41.75 inches. With this construction, when strap 22a is used with a form having a diameter of 14 inches, the strap is inserted into the opening 28 of a first brace support assembly 18 and is moved to a position where grommet 26-2 is in alignment with pin 38 of the brace support assembly. The alignment pin is then threaded inwardly of bore 36a of plate 36 and snugged down so as to secure the brace support assembly to the belt 22a at the location of grommet 26-2 to form a first assembly. The second brace support assembly 18 is moved to a position where grommet 26-1 is in alignment with pin 38 of the brace support assembly. The alignment pin is then threaded inwardly of bore 36a of plate 36 of the second brace support assembly and snugged down so as to secure the assembly to the belt 22a at the location of grommet 26-1 to form a second assembly comprising the strap assembly and the first and second strategically spaced apart brace support assemblies.

In accordance with one form of the method of the invention, after the construction of the second assembly is completed, the assembly can be interconnected with the upper portion of the 14 inch diameter form “F” in the manner illustrated in FIG. 1 of the drawings by placing the assembly about the form and securing it in place using the buckle assembly 24 in a conventional manner. As illustrated in FIG. 4 of the drawings, when the assemblage is in position about the form, the first and second brace support assemblies are spaced apart by an angle of approximately 90 degrees.

Following connection of the second assembly with the form “F”, the connector member 48 of the elongate first brace assembly 42 is inserted between and connected to attachment members 30 and 32 of the first brace support assembly 18 using the bolt 49. This done, the second end 46a of the brace of the first brace assembly is positioned in engagement with the supporting surface so that the brace extends outwardly from the form at an angle of approximately 45 degrees. The brace assembly is then secured in position by the stake 56 in the manner illustrated in FIG. 1. Next, the connector member 48 of the elongate second brace assembly 44 is inserted between and connected to attachment members 30 and 32 of the second brace support assembly 18 using the bolt 49. This done, the second end 46a of the brace of the second brace assembly is positioned in engagement with the supporting surface so that the brace extends outwardly from the form at an angle of approximately 45 degrees. The brace assembly is then secured in position by the stake 56 in the manner illustrated in FIG. 1.

As previously mentioned, strap 22a can be used in a similar manner in connection with a column form having a diameter of either 16 or 18 inches. When used with a form having a 16 inch diameter, the first brace support assembly is connected to the strap in the manner previously described at the location of the grommet 26-1. However, in this instance, the second brace support assembly is connected to the strap at the location of the grommet 26-3. Similarly, when used with a form having an 18 inch diameter the first brace support assembly is connected to the strap in the manner previously described at the location of the grommet 26-1. However, in this latter case, the second brace support assembly is connected to the strap at the location of the grommet 26-4. When strap 22a is used with either a 16 or 18 inch diameter form, the first and second brace support assemblies will be spaced apart by an angle of approximately 90 degrees.

Strap 22b is designed for use in a manner described in the preceding paragraphs with forms having diameters of 20 inches, 22 inches and 24 inches. Accordingly, as illustrated in FIG. 5A, sixth grommet 26-6 is spaced from fifth grommet 26-5 by a distance “D-4” of approximately 47.75 inches, seventh grommet 26-7 is spaced from fifth grommet 26-5 by a distance “D-5” of approximately 51.75 inches and eighth grommet 26-8 is spaced from fifth grommet 26-5 by a distance “D-6” of approximately 55.75 inches. By way of example, when strap 22b is used with a form having a diameter of 20 inches, the strap is inserted into the opening 28 of a first brace support assembly 18 and is moved to a position where grommet 26-6 is in alignment with pin 38 of the brace support assembly. The alignment pin is then threaded inwardly of bore 36a of plate 36 and snugged down so as to secure the brace support assembly to the belt 22b at the location of grommet 26-6 to form a first assembly. The second brace support assembly 18 is moved to a position where grommet 26-5 is in alignment with pin 38 of the brace support assembly. The alignment pin is then threaded inwardly of bore 36a of plate 36 of the second brace support assembly and snugged down so as to secure the assembly to the belt 22b at the location of grommet 26-5. The assemblage thus formed is interconnected with the 20 inch diameter form in the same manner as described in the preceding paragraphs. Similarly, the first and second brace assemblies are interconnected with the assemblage thus formed in the manner previously described. Strap 22b can be used in a similar manner with forms having diameters of 22 and 24 inches.

Strap 22c (see FIG. 5B) is designed for use in a manner described in the preceding paragraphs with forms having diameters of 26 inches, 28 inches and 30 inches. Accordingly, as illustrated in FIG. 5B, tenth grommet 26-10 is spaced from ninth grommet 26-9 by a distance “D-7” of approximately 62.00 inches, 11th grommet 26-11 is spaced from ninth grommet 26-9 by a distance “D-8” of approximately 66.00 inches and 12th grommet 26-12 is spaced from ninth grommet 26-9 by a distance “D-9” of approximately 70.00 inches. By way of example, when strap 22c is used with a form having a diameter of 26 inches, the strap is inserted into the opening 28 of a first brace support assembly 18 and is moved to a position where grommet 26-10 is in alignment with pin 38 of the brace support assembly. The alignment pin is then threaded inwardly of bore 36a of plate 36 and snugged down so as to secure the brace support assembly to the belt 22c at the location of grommet 26-10 to form a first assembly. The second brace support assembly 18 is moved to a position where grommet 26-9 is in alignment with pin 38 of the brace support assembly. The alignment pin is then threaded inwardly of bore 36a of plate 36 of the second brace support assembly and snugged down so as to secure the assembly to the belt 22c at the location of grommet 26-9. The assemblage thus formed is interconnected with the 26 inch diameter form in the same manner as described in the preceding paragraphs. Similarly, the first and second brace assemblies are interconnected with the assemblage thus formed in the manner previously described. Strap 22c can be used in a similar manner with forms having diameters of 28 inches and 30 inches.

Strap 22d (see FIG. 5C) is designed for use in a manner described in the preceding paragraphs with forms having diameters of 32 inches, 34 inches and 36 inches. Accordingly, as illustrated in FIG. 5C, 14th grommet 26-14 is spaced from 13th grommet 26-13 by a distance “D-10” of approximately 76.25 inches, 15th grommet 26-15 is spaced from 13th grommet 26-13 by a distance “D-11” of approximately 80.00 inches and 16th grommet 26-16 is spaced from 13th grommet 26-13 by a distance “D-12” of approximately 84.00 inches.

Strap 22e (see FIG. 5D) is designed for use in a manner described in the preceding paragraphs with forms having diameters of 44 inches, 46 inches and 48 inches. Accordingly, as illustrated in FIG. 5D, 18th grommet 26-18 is spaced from 17th grommet 26-17 by a distance “D-13” of approximately 104.00 inches, 19th grommet 26-19 is spaced from 17th grommet 26-17 by a distance “D-14” of approximately 108.50 inches and 20th grommet 26-20 is spaced from 17th grommet 26-17 by a distance “D-15” of approximately 112.25 inches. Strap 22e is used in connection with forms having diameters of 44 inches, 46 inches, and 48 inches, in the same manner as described in the preceding paragraphs.

Strap 22f (see FIG. 5E) is designed for use in a manner described in the preceding paragraphs with forms having diameters of 56 inches, 58 inches and 60 inches. Accordingly, as illustrated in FIG. 5E, 22nd grommet 26-22 is spaced from 21st grommet 26-21 by a distance “D-16” of approximately 132.75 inches, 23rd grommet 26-23 is spaced from 21st grommet 26-21 by a distance “D-17” of approximately 136.75 inches and 24th grommet 26-24 is spaced from 21st grommet 26-21 by a distance “D-18” of approximately 140.75 inches. Strap 22f is used in connection with forms having diameters of 56 inches, 58 inches and 60 inches, in the same manner as described in the preceding paragraphs.

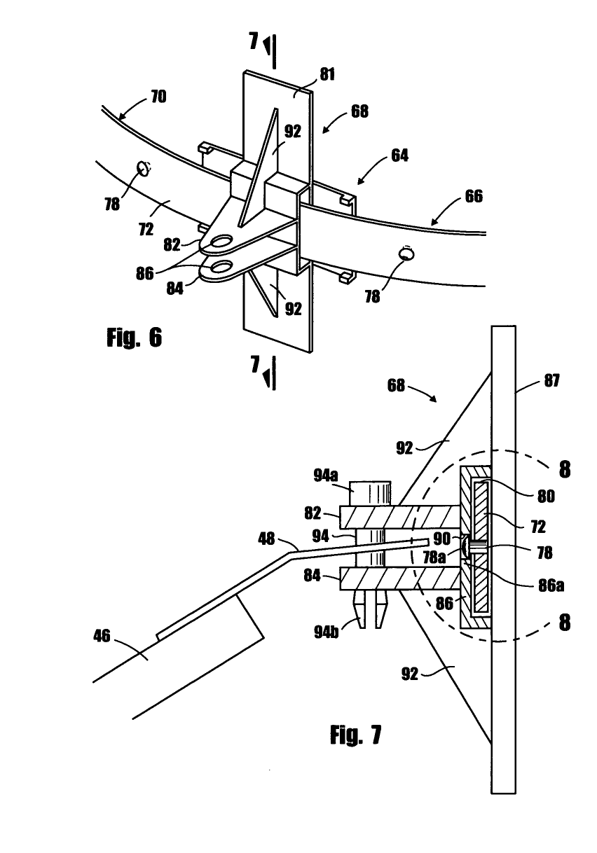

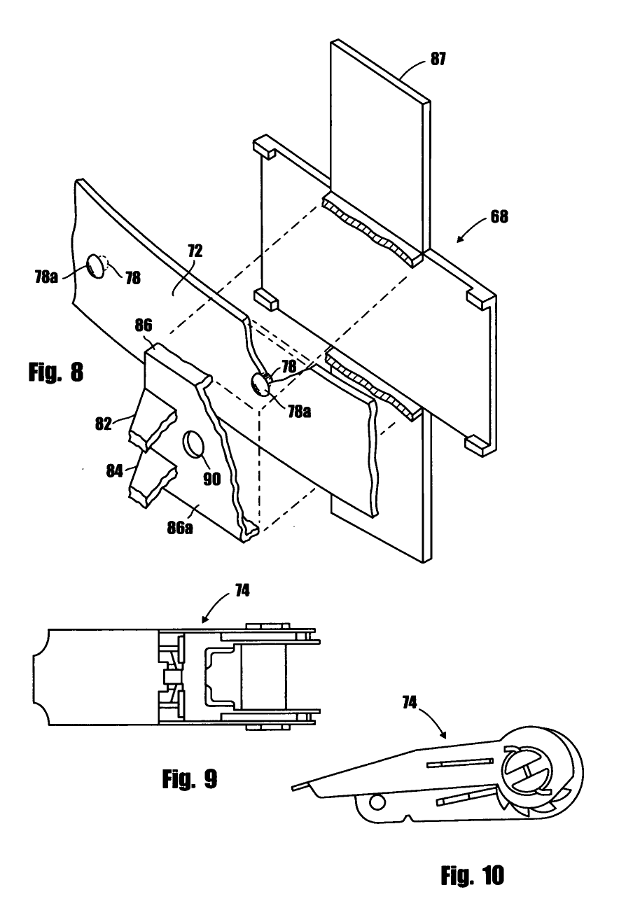

Referring next to FIGS. 6 through 10 of the drawings, an alternate form of the bracing apparatus of the invention is there shown. As will be discussed in the paragraphs which follow, this alternate form of bracing apparatus is similar in many respects to the apparatus illustrated in FIGS. 1 through 5 and like numerals are used in FIGS. 6 through 10 to identify like components. As before, a collar assembly 64 is constructed and arranged to be secured about an upright concrete column form “F”, such as that shown in FIG. 1 of the drawings, that can be used for pouring a concrete column. In this latest form of the invention, collar assembly 64 includes a strap assembly 66 and a pair of circumferentially spaced brace support assemblies 68 that are connected to the strap assemblies in a manner presently to be described.

As illustrated in FIG. 7 of the drawings, strap assembly 66 includes an elongated high tensile strap sub-assembly 70 that can be adjusted to accommodate column forms of various diameters. Strap sub-assembly 70 includes a strap 72 having first and second ends that are releasably interconnected in a conventional manner by a strap connector shown here as a ratchet type buckle 74 of the character illustrated in FIGS. 9 and 10 of the drawings. Ratchet buckle 74 is of a conventional design and is readily commercially available from various sources, including AGM Container Controls, Inc. of Tucson, Ariz.

As illustrated in FIGS. 6 and 7 of the drawings, a plurality of locator elements, here shown as locator rivets 78, are provided at strategically determined locations along strap 72. In a manner presently to be described, rivets 78 function to locate the brace support assemblies 68 at strategic locations along the strap (FIG. 6).

As best seen in FIGS. 6 and 7 of the drawings, each of the brace support assemblies 68 includes a strap receiving opening 80 that telescopically receives the strap 72. Each of the brace support assemblies 68 also includes a pair of vertically spaced attachment members 82 and 84. For a purpose presently to be described, each of the attachment members is provided with an aperture 86. Attachment members 82 and 84 are connected to and extend from a generally U-shaped member 86. U-shaped member 86 is, in turn, connected to a generally vertically extending support 87 and cooperates therewith to define the strap receiving opening 80. The forward wall 86a of the U-shaped is provided with a bore 90 that, in a manner presently to be described, receives the head portion 78a of a selected one of the locator elements, or rivets 78. Interconnecting the pair of vertically spaced attachment members 82 and 84 with the generally vertically extending support 87 are a pair of side supports 92.

Also forming an important part of the bracing apparatus of the present embodiment of the invention are elongate first and second brace assemblies 42 and 44 (FIG. 1). These first and second brace assemblies, which are substantially identical in construction and operation to those previously described in connection with the first embodiment of the invention, each include an elongated brace 46 having a first lower engagement end 46a and a second end 46b that includes a connector member 48 that is receivable between the pair of vertically spaced attachment members 82 and 84. Connector members 48 are interconnected with attachment members 82 and 84 by means of a plastic connector pin 94 that extends through apertures 86 and through an aperture 48a provided in connector member 48 (see FIG. 7). Connector pins 94 includes a head portion 94a and a yieldably deformable, split end portion 94b that is adapted to snap into the aperture of member 84 in the manner illustrated in FIG. 7. As in the earlier described embodiment of the invention, connected to the second end 46b of each of the connector members is a connector assembly 52 that includes an apertured member 54 and a securement stake 56 that functions to secure the brace 46 in position (see FIG. 1).

As before, the bracing apparatus of this latest form of the invention includes a plurality of straps 72 of different lengths and different configurations. Straps 72 are of similar construction and operation to those illustrated in FIGS. 5, 5A, 5B, 5C, 5D and 5E. However, instead of the straps having a plurality of strategically spaced apart locator elements, such as grommets that function to locate the brace support assemblies at predetermined locations along the strap, straps 72 are here provided with a plurality of the previously identified locator elements, or rivets 78 that are spaced apart along the straps at the same intervals as the grommets shown FIGS. 5, 5A, 5B, 5C, 5D and 5E. As shown in FIG. 7 of the drawings, each of the locator rivets has an upstanding head portion 78a that, as the strap slides within the strap receiving opening 80, is receivable within bore 90 formed in the forward wall 86a of the U-shaped member 86. With this novel construction, instead of the threaded pin 38 cooperating with the locating grommet to locate the brace support assembly as in the first embodiment of the invention, the strategically placed rivets 78 cooperate with opening 80 to locate the brace support assembly at strategic locations along the strap 72.

As in the earlier described embodiment of the invention, in this latest embodiment a number of straps are provided to accommodate the forms of various sizes as earlier described. Similarly, as previously mentioned, the rivets 76 are spaced apart at the same intervals as the grommets 26 illustrated in FIGS. 5, 5A, 5B, 5C, 5D and 5E. Accordingly, in the interest of brevity, these figures will not be duplicated to merely illustrate positioning of the rivets 76.

By way of example, one of the straps 72 of this latest form of the invention can be designed for use with forms having diameters of 14 inches, 16 inches and 18 inches. With such a strap, a second rivet is spaced from a first rivet by a distance of approximately 33.75 inches, a third rivet is spaced from the first rivet by a distance of approximately 37.75 inches and a fourth rivet is spaced from the first rivet by a distance of approximately 41.75 inches (see FIG. 5). With this construction, when the strap is used with a form having a diameter of 14 inches, the strap is inserted into the opening 80 of a first brace support assembly 68 and is moved to a position where the head portion of the second rivet seats within the opening 90 formed in the face 86a of U-shaped member 86 of one of the brace support assemblies so as to locate the brace support assembly at the location of the second rivet to form a first assembly. A second brace support assembly 68 is moved to a position where the head portion of the first rivet seats within the opening 90 formed in the face 86a of U-shaped member 86 of one of the second brace support assemblies so as to locate the second brace support assembly at the location of the first rivet to form a second assembly comprising the strap assembly and the first and second brace support assemblies that are spaced apart by a distance of approximately 33.75 inches.

In accordance with an alternate form of the method of the invention, after the construction of the second assembly of this alternate embodiment of the invention is completed, the assembly can be interconnected with the upper portion of the 14 inch diameter form “F” in the manner illustrated in FIG. 1 of the drawings by placing the assembly about the form and securing it in place using the ratchet type buckle assembly 74 in a conventional manner. When the assemblage is in position about the form, the first and second brace support assemblies of this latest embodiment of the invention are spaced apart by an angle of approximately 90 degrees.

Following connection of the second assembly of this latest embodiment of the invention with the form “F”, the connector member 48 of the elongate first brace assembly 42 is inserted between and connected to attachment members 82 and 84 of the first brace support assembly 68 using the connector pin 94. This done, the second end 46a of the brace of the first brace assembly is positioned in engagement with the supporting surface so that the brace extends outwardly from the form at an angle of approximately 45 degrees. The brace assembly is then secured in position in the manner illustrated in FIG. 1. Next, the connector member 48 of the elongate second brace assembly 44 is inserted between and connected to attachment members 82 and 84 of the second brace support assembly 68 using the connector pin 94. This done, the second end 46a of the brace of the second brace assembly is positioned in engagement with the supporting surface so that the brace extends outwardly from the form at an angle of approximately 45 degrees. The brace assembly is then secured in position in the manner illustrated in FIG. 1.

As previously mentioned, and in a manner similar to that described in connection with the first embodiment of the invention, a second strap of a different length can be used in a similar manner in connection with a column form having a diameter of 16, 18, or of a greater diameter.

Having now described the invention in detail in accordance with the requirements of the patent statutes, those skilled in this art will have no difficulty in making changes and modifications in the individual parts or their relative assembly in order to meet specific requirements or conditions. Such changes and modifications may be made without departing from the scope and spirit of the invention, as set forth in the following claims.

1. A bracing apparatus for bracing a generally vertically extending member comprising:
(a) a collar assembly constructed and arranged to be secured about the generally vertically extending member, said collar assembly including a strap having a plurality of spaced apart locator elements and a plurality of circumferentially spaced brace support assemblies connected to said strap at the location of selected ones of said locator elements, each said brace support assembly having a strap receiving opening and an attachment member;
(b) an elongate first brace having a first surface engagement end and a second end for interconnection with said attachment member of a selected one of said plurality of circumferentially spaced apart brace support assemblies; and
(c) an elongate second brace having a first surface engagement end and a second end for interconnection with said attachment member of a selected one of said plurality of circumferentially spaced brace support assemblies.

2. The bracing apparatus as defined in claim 1 in which each of said attachment members of each said brace support assembly has an aperture; in which a connector member is connected to said second end of each of said elongate first and second braces, each of said connector members having an aperture; and in which each of said brace support assemblies further includes a connector member receivable within said apertures.

3. The bracing apparatus as defined in claim 1 in which said locator elements comprise a plurality of spaced apart locating grommets.

4. The bracing apparatus as defined in claim 1 in which said locator elements comprise a plurality of spaced apart rivets.

5. A bracing apparatus for bracing a vertical form for pouring a concrete column comprising:
(a) a collar assembly constructed and arranged to be secured about the form, said collar assembly including a strap and a plurality of circumferentially spaced brace support assemblies connected to said strap, each said brace support assembly having an attachment member;
(b) an elongate first brace having a first surface engagement end and a second end for interconnection with said attachment member of a selected one of said plurality of circumferentially spaced apart brace support assemblies; and
(c) an elongate second brace having a first surface engagement end and a second end for interconnection with said attachment member of a selected one of said plurality of circumferentially spaced brace support assemblies.

6. The bracing apparatus as defined in claim 5 in which each of said attachment members of each said brace support assembly has an aperture; in which a connector member is connected to said second end of each of said elongate first and second braces, each of said connector members having an aperture; and in which each of said brace support assemblies further includes a connector member receivable within said apertures.

7. The bracing apparatus as defined in claim 7 in which said strap of said collar assembly includes first, second, third and fourth spaced apart locating grommets and in which each of said brace support assemblies includes a locating pin receivable within a selected one of said first, second, third, and fourth spaced apart locating grommets.

8. The bracing apparatus as defined in claim 7 in which said second grommet is spaced from said first grommet by a distance of approximately 33.75 inches.

9. The bracing apparatus as defined in claim 7 in which said third grommet is spaced from said first grommet by a distance of approximately 37.75 inches and in which said fourth grommet is spaced from said first grommet by a distance of approximately 41.75 inches.

10. A bracing apparatus for bracing a vertical form for pouring a concrete column comprising:
(a) a collar assembly constructed and arranged to be secured about the form, said collar assembly including:
(i) a strap assembly including an elongated strap having first and second ends, a ratchet buckle releasably interconnecting said first and second ends and first, second, third and fourth spaced apart locating grommets; and
(ii) a plurality of circumferentially spaced brace support assemblies connected to said strap, each of said brace support assemblies having a strap receiving opening and comprising:
a. a pair of vertically spaced attachment members;
b. a generally vertically extending support; and
c. a locating pin connected to said generally vertically extending support, said locating pin being receivable within a selected one of said first, second, third and fourth spaced apart locating grommets of said strap; and
(b) an elongate first brace having a first surface engagement end and a second end receivable between and interconnected with said pair of vertically spaced attachment members of a selected one of said plurality of circumferentially spaced apart brace support assemblies; and
(c) an elongate second brace having a first surface engagement end and a second end receivable between and interconnected with said pair of vertically spaced attachment members of a selected one of said plurality of circumferentially spaced brace support assemblies.

11. The bracing apparatus as defined in claim 10 in which each of said vertically spaced attachment members of each said brace support assemblies has an aperture; in which said second end of each of said elongate first and second braces has an aperture; and in which each of said brace support assemblies further includes a connector receivable within said apertures.

12. The bracing apparatus as defined in claim 11 in which each of said brace support assemblies further includes reinforcement members interconnecting said pair of vertically spaced attachment members with said generally vertical support.

13. The bracing apparatus as defined in claim 11 in which said second end of each of said elongate first and second braces comprises a generally planar member receivable between said vertically spaced attachment members of a selected one of said plurality of circumferentially spaced brace support assemblies.

14. The bracing apparatus as defined in claim 11 in which said second grommet of said elongated strap is spaced from said first grommet of said belt by a distance of approximately 47.75 inches.

15. The bracing apparatus as defined in claim 14 in which said third grommet of said elongated strap is spaced from said first grommet of said elongated strap by a distance of approximately 51.75 inches and in which said fourth grommet of said elongated strap is spaced from said first grommet by a distance of approximately 55.75 inches.

16. The bracing apparatus as defined in claim 15 in which said third grommet of said belt is spaced from said first grommet of said belt by a distance of approximately 66 inches and in which said fourth grommet of said belt is spaced from said first grommet by a distance of approximately 70 inches.

17. A method for accurately plumbing and securing in position a column form into which concrete is to be poured to form a concrete column using a bracing apparatus comprising a collar assembly constructed and arranged to be secured about the form, said collar assembly including a strap having first, second, third and fourth spaced apart locating elements and first and second spaced apart brace support assemblies, each said brace support assembly having a strap receiving opening and a surface having an aperture; an elongate first brace having a first supporting surface engagement end and a second end having a connector member and an elongate second brace having a first supporting surface engagement end and a second end having a connector member, said method comprising the steps of:
(a) aligning a selected one of said first, second, third and fourth spaced apart locating elements with said aperture of said surface of said second brace support assembly having an aperture to form a first assembly;
(b) aligning a selected another one of said first, second, third and fourth spaced apart locating elements with said aperture of said surface of said first brace support assembly having an aperture to form a second assembly;
(c) connecting said connector member of said elongate first brace to said attachment member of said first brace support assembly and placing said first end of said elongate first brace into engagement with said supporting surface; and
(e) connecting said connector member of said elongate second brace to said attachment member of said second brace support assembly and a placing said first end of said elongate second brace into engagement with said supporting surface.

18. The method as defined in claim 17 in which said bracing apparatus further comprises a plurality of straps of different lengths and different configurations and in which said method comprises the step of, prior to forming said first assembly, selecting one of said plurality of straps of different lengths and configurations.
